(19) United States
(12) Patent Application Publication
(10) Pub. No.: US 2021/0312139 A1
(43) Pub. Date: Oct. 7, 2021

(54) METHOD AND APPARATUS OF GENERATING SEMANTIC FEATURE, METHOD AND APPARATUS OF TRAINING MODEL, ELECTRONIC DEVICE, AND STORAGE MEDIUM

(71) Applicant: Beijing Baidu Netcom Science Technology Co., Ltd., Beijing (CN)

(72) Inventors: Shuohuan WANG, Beijing (CN); Siyu DING, Beijing (CN); Junyuan SHANG, Beijing (CN); Yu SUN, Beijing (CN)

(21) Appl. No.: 17/353,884

(22) Filed: Jun. 22, 2021

(30) Foreign Application Priority Data
Dec. 25, 2020 (CN) 202011562653.0

(51) Int. Cl. G06F 40/30; G06N 20/00; G06N 5/04

(52) U.S. Cl. CPC G06F 40/30; G06N 5/04; G06N 20/00

(57) ABSTRACT

A method and apparatus of generating a semantic feature, a method and apparatus of training a model, an electronic device, and a storage medium are provided. The method of generating the semantic feature includes: segmenting a target document to obtain a segment sequence of the target document; generating a semantic feature of each document segment in the segment sequence of the target document by using a pre-trained bidirectional semantic encoding model; and acquiring the semantic feature of the target document based on the semantic feature of the each document segment in the segment sequence of the target document. The present disclosure further provides a method of training a bidirectional semantic encoding model.

### CROSS-REFERENCE TO RELATED APPLICATION(S)

The present disclosure claims priority to Chinese Patent Application No. 202011562653.0, filed on Dec. 25, 2020 the disclosure of which is incorporated herein by reference in their entirety.

### TECHNICAL FIELD

The present disclosure relates to a field of computer technology, specifically to a field of artificial intelligence technology such as machine learning and natural language processing, and in particular to a method and an apparatus of generating a semantic feature, a method of training a model, an electronic device, and a storage medium.

### BACKGROUND

Semantic retrieval is a core technology in search engines, that is, for a given search term such as a Query entered by a user, how to quickly retrieve a candidate document most relevant to semantics of the Query from a document library.

A semantic representation for the Query and a semantic representation for each document in the document library may be calculated respectively. Then, Approximate Nearest Neighbor (ANN) technology may be used to perform the semantic retrieval based on the semantic representation for the query and the semantic representation for the each document in the document library, to obtain top K most relevant candidate documents. The semantic representation for the document may take a representation for one or more important domains of the document. For example, a semantic representation for title, abstract, etc. of the document may be taken as the semantic representation for the document.

### SUMMARY

According to an aspect of the present disclosure, there is provided a method of generating a semantic feature, including:

segmenting a target document to obtain a segment sequence of the target document;

generating a semantic feature of each document segment in the segment sequence of the target document by using a pre-trained bidirectional semantic encoding model; and

acquiring a semantic feature of the target document based on the semantic feature of the each document segment in the segment sequence of the target document.

According to another aspect of the present disclosure, there is provided a method of training a bidirectional semantic encoding model, including:

acquiring a training data set; and

training the bidirectional semantic encoding model including a left encoding module and a right encoding module, based on the training data set acquired.

According to another aspect of the present disclosure, there is provided an apparatus of generating a semantic feature, including:

a segmentation module configured to segment a target document to obtain a segment sequence of the target document;

a generation module configured to generate a semantic feature of each document segment in the segment sequence of the target document by using a pre-trained bidirectional semantic encoding model; and

an acquisition module configured to acquire a semantic feature of the target document based on the semantic feature of the each document segment in the segment sequence of the target document.

According to another aspect of the present disclosure, there is provided an apparatus of training a bidirectional semantic encoding model, including:

an acquisition module configured to acquire a training data set; and

a training module configured to train the bidirectional semantic encoding model including a left encoding module and a right encoding module, based on the training data set acquired.

According to another aspect of the present disclosure, there is provided an electronic device, including:

at least one processor; and

a memory communicatively connected to the at least one processor, wherein the memory stores instructions executable by the at least one processor, and the instructions, when executed by the at least one processor, cause the at least one processor to implement the method described above.

According to another aspect of the present disclosure, there is provided a non-transitory computer-readable storage medium having computer instructions stored thereon, wherein the computer instructions, when executed by a computer, cause the computer to implement the method described above.

According to another aspect of the present disclosure, there is provided a computer program product containing a computer program, wherein the computer program, when executed by a processor, causes the processor to implement the method described above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure, in which:

FIG. 1 shows a schematic diagram according to a first embodiment of the present disclosure;

FIG. 2 shows a schematic diagram according to a second embodiment of the present disclosure;

FIG. 3 shows a schematic structural diagram of a bidirectional semantic encoding model of the embodiment;

FIG. 4 shows an operation principle diagram of a Transformer-XL model of the embodiment;

FIG. 5 shows an attention mechanism diagram of the Transformer-XL model shown in FIG. 4;

FIG. 6 shows an operation principle diagram of a left encoding module of the embodiment;

FIG. 7 shows an operation principle diagram of a right encoding module of the embodiment;

FIG. 8 shows an attention mechanism diagram of a bidirectional semantic encoding model of the embodiment;

FIG. 9 shows a schematic diagram according to a third embodiment of the present disclosure;

FIG. 10 shows a schematic diagram according to a fourth embodiment of the present disclosure;

FIG. 11 shows a schematic diagram of a mask training for the left encoding module and the right encoding module of the embodiment;

FIG. 12 shows a schematic diagram according to a fifth embodiment of the present disclosure;

FIG. 13 shows a schematic diagram according to a sixth embodiment of the present disclosure;

FIG. 14 shows a schematic diagram according to a seventh embodiment of the present disclosure;

FIG. 15 shows a schematic diagram according to an eighth embodiment of the present disclosure; and

FIG. 16 shows a block diagram of an electronic device for implementing the embodiments of the present disclosure.

### DETAILED DESCRIPTION OF EMBODIMENTS

The exemplary embodiments of the present disclosure are described below with reference to the accompanying drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

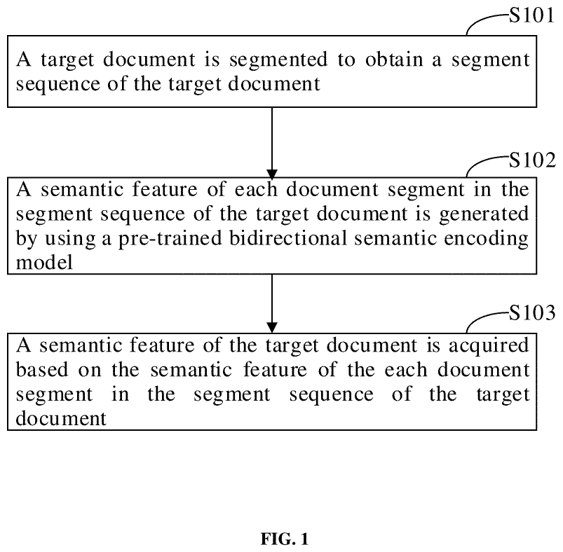

FIG. 1 shows a schematic diagram according to a first embodiment of the present disclosure. As shown in FIG. 1, this embodiment provides a method of generating a semantic feature, which may specifically include following steps.

In step S101, a target document is segmented to obtain a segment sequence of the target document.

In step S102, a semantic feature of each document segment in the segment sequence of the target document is generated by using a pre-trained bidirectional semantic encoding model.

In step S103, a semantic feature of the target document is acquired based on the semantic feature of the each document segment in the segment sequence of the target document.

An execution entity of the method of generating the semantic feature in this embodiment is an apparatus of generating the semantic feature, which may be an electronic entity or may be an application integrated with software. The apparatus of generating the semantic feature in this embodiment is used to generate the semantic feature of the each document segment in the target document by using the pre-trained bidirectional semantic encoding model.

The target document in this embodiment may be any document in a document library. The document in the document library in this embodiment may be a long document containing a plurality of sentences or paragraphs. For example, the document may be a piece of news, an e-book, or other long document containing a plurality of sentences on the Internet. Alternatively, the target document in this embodiment may be a document in which punctuation is removed and only text information in the document is retained. However, upon theoretical proof, even if the punctuation is not removed, a subsequent processing effect will not be affected.

In this embodiment, the target document may be segmented first to obtain the segment sequence of the target document. The segment sequence of the target document may include at least two document segments arranged in sequence according to a sequence in the target document. Specifically, in this embodiment, the target document may be segmented according to a fixed preset length. In this way, according to an order from front to back, the document segments except for a last document segment theoretically have a same length.

In this embodiment, the semantic feature of the each document segment in the segment sequence of the target document is generated by using the pre-trained bidirectional semantic encoding model. The bidirectional semantic encoding model may encode the each document segment in two directions, so that the semantic feature of the encoded document segment is more accurate. Finally, in a specific Natural Language Processing (NLP) task, the semantic feature of the target document may be acquired based on the semantic feature of the each document segment in the segment sequence of the target document. For example, in a semantic matching task, the semantic feature of the target document may be acquired based on the semantic feature of the each document segment in the segment sequence of the target document and by referring to a semantic feature of a search term to be matched. For example, in other tasks, the semantic feature of the target document may be generated directly based on the semantic feature of the each document segment in the segment sequence of the target document. For example, the semantic feature of the target document may be generated by mathematical operations such as averaging, based on the semantic feature of the each document segment in the segment sequence of the target document.

An applicable scenario for the method of generating the semantic feature in the embodiment may be as follows. After a user enters a search term, documents are searched in the document library based on the search term. Each document is taken as the target document, a semantic feature of each document segment in the segment sequence of each target document may be generated according to the method in the embodiment. Then, the semantic matching task may be implemented based on the semantic feature of the each document segment in the segment sequence of the each target document, and a document related to the search term may be retrieved, so that the accuracy and efficiency of document matching may be effectively improved. In addition, the method of generating the semantic feature in this embodiment may also be applied to other NLP tasks, which will not be illustrated here.

In the method of generating the semantic feature in this embodiment, the target document is segmented to obtain the segment sequence of the target document, the semantic feature of the each document segment in the segment sequence of the target document is generated by using the pre-trained bidirectional semantic encoding model, and the semantic feature of the target document is acquired based on the semantic feature of the each document segment in the segment sequence of the target document. In the technical solution of the present disclosure, by adopting the pre-trained bidirectional semantic encoding model, the accuracy of the semantic feature of the each document segment in the target document may be effectively improved, so that the accuracy of the semantic feature representation for the target document may be effectively improved.

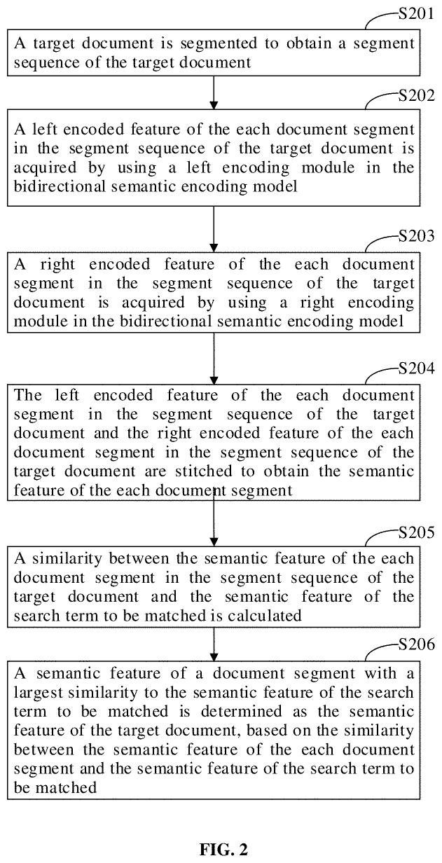

FIG. 2 shows a schematic diagram according to a second embodiment of the present disclosure. On the basis of the technical solution of the embodiment shown in FIG. 1, the technical solution of the present disclosure is described in more detail in a method of generating a semantic feature in the embodiment shown in FIG. 2. As shown in FIG. 2, the method of generating the semantic feature in this embodiment may specifically include following steps.

In step S201, a target document is segmented to obtain a segment sequence of the target document.

For implementation of this step, reference may be made to the step S101 in the embodiment shown in FIG. 1, which will not be repeated here.

In step S202, a left encoded feature of the each document segment in the segment sequence of the target document is acquired by using a left encoding module in the bidirectional semantic encoding model.

In step S203, a right encoded feature of the each document segment in the segment sequence of the target document is acquired by using a right encoding module in the bidirectional semantic encoding model.

In step S204, the left encoded feature of the each document segment in the segment sequence of the target document and the right encoded feature of the each document segment in the segment sequence of the target document are stitched to obtain the semantic feature of the each document segment.

The step S202 to the step S204 in this embodiment are an implementation of the step S102 in the embodiment shown in FIG. 1.

In step S205, a similarity between the semantic feature of the each document segment in the segment sequence of the target document and the semantic feature of the search term to be matched is calculated.

In step S206, a semantic feature of a document segment with a largest similarity to the semantic feature of the search term to be matched is determined as the semantic feature of the target document, based on the similarity between the semantic feature of the each document segment and the semantic feature of the search term to be matched.

In this embodiment, a scenario of searching the document matching the search term in the document library based on the search term entered by the user is illustrated by way of example in describing the technical solution of the present disclosure. In this case, the step S103 in the embodiment shown in FIG. 1 may specifically include: acquiring the semantic feature of the target document based on the semantic feature of the each document segment in the segment sequence of the target document and by referring to a semantic feature of a search term to be matched. Further, in this embodiment, step S205 and step S206 for acquiring the semantic feature of the target document based on the semantic feature of the each document segment in the segment sequence of the target document and by referring to the semantic feature of the search term to be matched are illustrated by way of example in describing the technical solution of the present disclosure. In practice, in other NLP tasks, the step S103 in the embodiment shown in FIG. 1 may also be implemented in other ways, which will not be illustrated here.

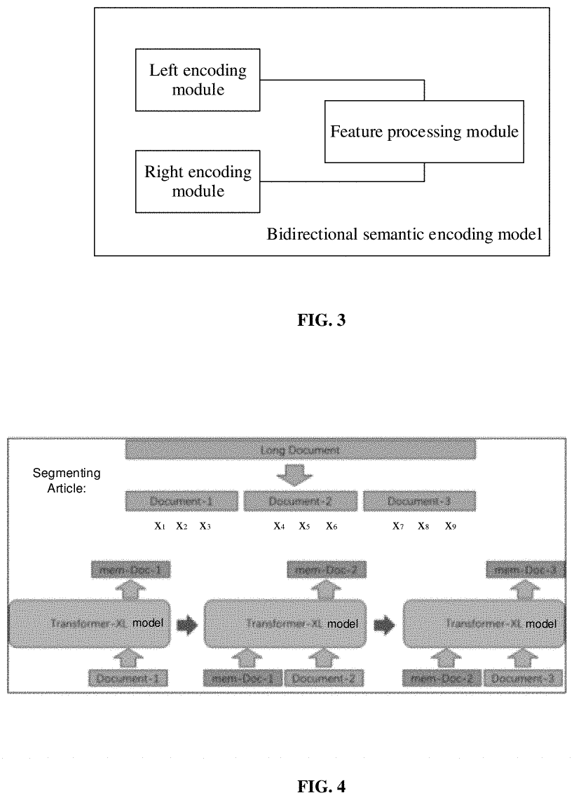

FIG. 3 shows a schematic structural diagram of a bidirectional semantic encoding model of the embodiment. As shown in FIG. 3, the bidirectional semantic encoding model of this embodiment includes a left encoding module and a right encoding module.

The bidirectional semantic encoding model of this embodiment may be referred to as a Bi-Transformer-XL model, which may be improved based on existing Transformer-XL or XLNet. For example, FIG. 4 shows an operation principle diagram of a Transformer-XL model of the embodiment. As shown in FIG. 4, the Transformer-XL model models a document in segments from left to right. For example, in FIG. 4, a document containing X1, X2, . . . X9 is divided into three document segments including Document-1, Document-2 and Document-3. Suppose that a maximum length of single modeling in this embodiment is 3, and Document-1 includes X1, X2 and X3, Document-2 includes X4, X5 and X6, and Document-3 includes X7, X8 and X9.

As shown in FIG. 4, when the Transformer-XL model operates, Document-1, Document-2 and Document-3 are sequentially input into the Transformer-XL model. The Transformer-XL model first performs encoding based on X1, X2 and X3 in Document-1 to obtain an encoded result mem-Doc-1, then performs encoding based on the encoded result mem-Doc-1 of Document-1 and X4, X5, X6 in Document-2 to obtain an encoded result mem-Doc-2, and then performs encoding based on the encoded result mem-Doc-2 of Document-2 and X7, X8, X8 in Document-3 to obtain an encoded result mem-Doc-3.

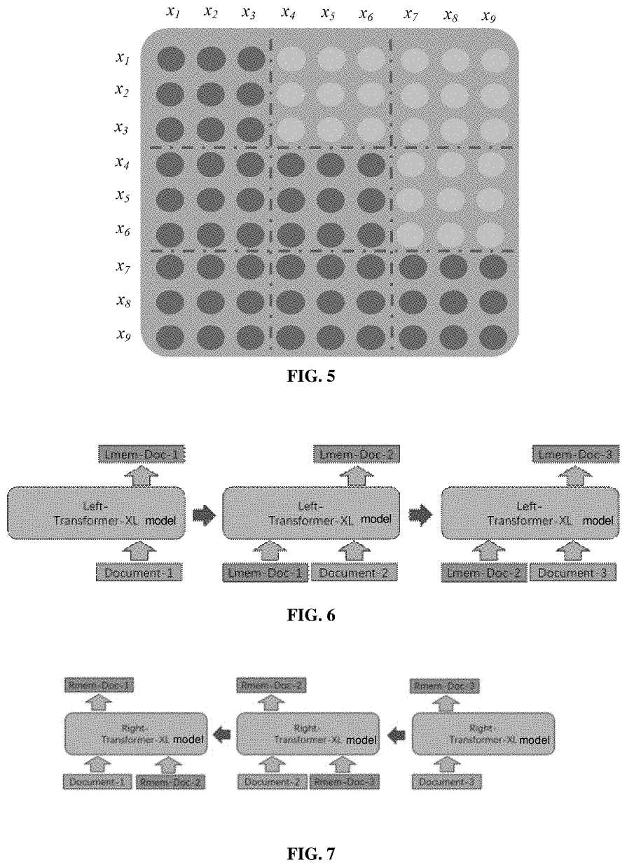

FIG. 5 shows an attention mechanism diagram of the Transformer-XL model shown in FIG. 4. The attention mechanism shown in FIG. 5 may be obtained by combining with the operation principle shown in FIG. 4. As shown in FIG. 5, the Transformer-XL model has bidirectional attention in each document segment. For example, in Document-1, X1-X3 are internally visible and perceivable, so does X4-X6 in Document-2 and X7-X9 in Document-3. Since Document-2 is encoded by referring to the encoded result of Document-1, and Document-3 is encoded by referring to the encoded result of Document-2, the attention mechanism between different document segments is unidirectional, such as from left to right. Such modeling limits an ability of the model. For example, the semantic representation for the leftmost character X1 may not refer to characters X4 to X9 in Document-2 and Document-3.

On the basis of the limited ability of the Transformer-XL model described above, the bidirectional semantic encoding model in this embodiment, namely the Bi-Transformer-XL model, may perform modeling by using two joint models, so that the semantic feature is modeled from left to right and from right to left, respectively. That is, the left encoding module in the bidirectional semantic encoding model performs modeling from left to right, and the right encoding module performs modeling from right to left. The left encoding module may be referred to as Left-Transformer-XL model, and the right encoding module may be referred to as Right-Transformer-XL. The document segments input to the left encoding module are sequentially input from left to right. FIG. 6 shows an operation principle diagram of the left encoding module of this embodiment, which is the same as that of the Transformer-XL model shown in FIG. 4, and an attention mechanism of the left encoding module is shown in FIG. 5. FIG. 7 shows an operation principle diagram of the right encoding module of this embodiment. As shown in FIG. 6, the operation principle of the right encoding module is symmetrical with that of the left encoding module, and the document segments input to the right encoding module are sequentially input from right to left.

For example, when the right encoding module (that is, the Right-Transformer-XL model) operates, Document-3, Document-2 and Document-1 are sequentially input into the Right-Transformer-XL model. The Right-Transformer-XL model first performs encoding based on X7, X8 and X9 in Document-3 to obtain an encoded result Rmem-Doc-3, then performs encoding based on the encoded result Rmem-Doc-3 of Document-3 and X4, X5, X6 in Document-2 to obtain an encoded result Rmem-Doc-2, and then performs encoding based on the encoded result Rmem-Doc-2 of Document-2 and X1, X2, X3 in Document-1 to obtain an encoded result Rmem-Doc-1.

For example, referring to FIG. 6, in the implementation of the step S202, Lmem-Doc-1, Lmem-Doc-2 and Lmem-Doc-3 may be used as the left encoded feature of Document-1, the left encoded feature of Document-2 and the left encoded feature of Document-3, respectively.

Similarly, referring to FIG. 7, in the implementation of the step S203, Rmem-Doc-3, Rmem-Doc-2 and Rmem-Doc-1 may be used as the right encoded feature of Document-3, the right encoded feature of Document-2 and the right encoded feature of Document-1, respectively.

As shown in FIG. 3, the bidirectional semantic encoding model further includes a feature processing module, which may stitch the left encoded feature and the right encoded feature of the document segment to obtain the semantic feature of the document segment. For example, for the document segment Document-1, Lmem-Doc-1 and Rmem-Doc-1 may be stitched to obtain the semantic feature of Document-1. A generation of Rmem-Doc-1 refers to the right encoded result Rmem-Doc-2 of Document-2 and the right encoded result Rmem-Doc-3 of Document-3. Therefore, it may be considered that the semantic feature of Document-1 obtained in this way may refer to X4-X6 in Document-2 and X7-X9 in Document-3, so that the semantic feature of Document-1 obtained may refer to semantic information of all contexts.

Similarly, for the document segment Document-2, Lmem-Doc-2 and Rmem-Doc-2 may be stitched to obtain the semantic feature of Document-2. A generation of Lmem-Doc-2 refers to the left encoded result Lmem-Doc-1 of Document-1, and a generation of Rmem-Doc-2 refers to the right encoded result Rmem-Doc-3 of Document-3. Therefore, it may be considered that the semantic feature of Document-2 obtained in this way may refer to X1-X3 in Document-1 and X7-X9 in Document-3, so that the semantic feature of Document-2 obtained may refer to semantic information of all contexts.

Similarly, for the document segment Document-3, Lmem-Doc-3 and Rmem-Doc-3 may be stitched to obtain the semantic feature of Document-3. A generation of Lmem-Doc-3 refers to the left encoded result Lmem-Doc-2 of Document-2, and a generation of Lmem-Doc-2 refers to the left encoded result Lmem-Doc-1 of Document-1. Therefore, it may be considered that the semantic feature of Document-3 obtained in this way may refer to X1-X3 in Document-1 and X4-X6 in Document-2, so that the semantic feature of Document-3 obtained may refer to semantic information of all contexts.

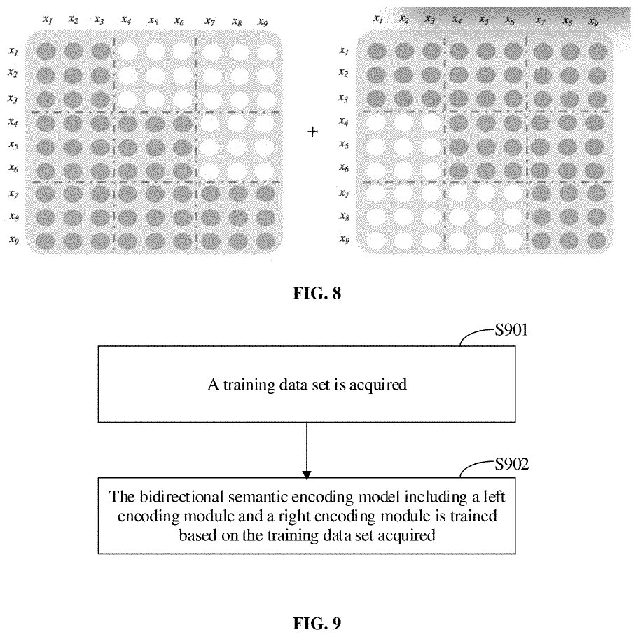

On the basis of the above description, an attention mechanism diagram of the bidirectional semantic encoding model shown in FIG. 8 may be obtained. As shown in FIG. 8, the attention mechanism diagram of the left encoding module is shown on left side, which is the same as the attention mechanism diagram of the Transformer-XL model shown in FIG. 5. An attention mechanism diagram of the right encoding module is shown on right side, which is symmetrical with that of the left encoding module. By stitching the left encoded feature and the right encoded feature, the semantic feature of each document segment obtained finally may fully refer to the semantic information of all contexts to dynamically perform the semantic representation, so that a semantic feature representation effect of the bidirectional semantic encoding model is improved, and the accuracy of the semantic feature of the each document segment is improved.

In the semantic matching scenario of this embodiment, after the semantic feature of the document segment is acquired, a similarity between the semantic feature of the each document segment in the segment sequence of the target document and the semantic feature of the search term to be matched may be calculated by referring to the step S205 and the step S206 described above. The semantic feature of the search term to be matched in this embodiment may also be generated using the pre-trained bidirectional semantic encoding model. For example, the search term to be matched in this embodiment may be a search term entered by the user. A length of the search term to be matched is shorter than the preset length used for segmenting the target document. Therefore, in this embodiment, when generating the semantic feature of the search term to be matched, the search term to be matched may not be segmented. Instead, the search term to be matched is input directly into the bidirectional semantic encoding model. Then the left encoding module performs encoding to obtain a left encoded feature of the search term to be matched, and the right encoding module performs encoding to obtain a right encoded feature of the search term to be matched. The left encoded feature of the search term to be matched and the right encoded feature of the search term to be matched are stitched to obtain the semantic feature of the search term to be matched. In practice, the semantic feature of the search term to be matched may also be acquired in other ways, which is not limited here.

Subsequently, a semantic feature of a document segment with a largest similarity to the semantic feature of the search term to be matched is determined based on the similarity between the semantic feature of the each document segment and the semantic feature of the search term to be matched, as the semantic feature of the target document.

Further, in semantic matching, each document in the document library may be used as the target document. The semantic feature of the each document may be acquired according to the manner in this embodiment, and then the similarity between the semantic feature of the each document and the semantic feature of the search term to be matched may be calculated, and the document with the largest similarity is determined as the candidate document to achieve the semantic matching search. In the manner of this embodiment, the accuracy of the semantic feature of the document adopted is very high, so that the accuracy of the semantic matching task may be effectively improved.

In the method of generating the semantic feature in this embodiment, by using the left encoding module and the right encoding module in the bidirectional semantic encoding model, the semantic feature of each document segment may fully refer to the semantic information of all contexts to dynamically perform the semantic representation, so that the accuracy of the semantic feature representation for the document may be effectively improved.

FIG. 9 shows a schematic diagram according to a third embodiment of the present disclosure. FIG. 9 shows a method of training a bidirectional semantic encoding model provided in this embodiment. As shown in FIG. 9, the method of training the bidirectional semantic encoding model in this embodiment may specifically include following steps.

In step S901, a training data set is acquired.

In step S902, the bidirectional semantic encoding model including a left encoding module and a right encoding module is trained based on the training data set acquired.

An execution entity of the method of training the bidirectional semantic encoding model in this embodiment may be an apparatus of training the bidirectional semantic encoding model, which may be an electronic entity or may be an application integrated with software, for training the bidirectional semantic encoding model including the left encoding module and the right encoding module.

In other words, the bidirectional semantic encoding model of this embodiment includes the left encoding module and the right encoding module. The left encoding module in this embodiment may be understood as encoding input text information from left to right to obtain a corresponding left encoded feature. The right encoding module in this embodiment may be understood as encoding the input text information from right to left to obtain a corresponding right encoded feature. By using the left encoding module and the right encoding module, the bidirectional semantic encoding model of this embodiment achieves the encoding of the input text information in two directions, so that the encoded semantic feature obtained finally is more accurate. Specifically, the bidirectional semantic encoding model used in the embodiment shown in FIG. 2 may be used in this embodiment. Reference may be made to the relevant description in the above embodiment, which will not be repeated here.

In the method of training the bidirectional semantic encoding model in this embodiment, the training data set is acquired, and the bidirectional semantic encoding model including the left encoding module and the right encoding module is trained based on the training data set acquired. In this way, the bidirectional semantic encoding model may be effectively trained, so that an accuracy of the semantic feature represented by the bidirectional semantic encoding model may be effectively improved.

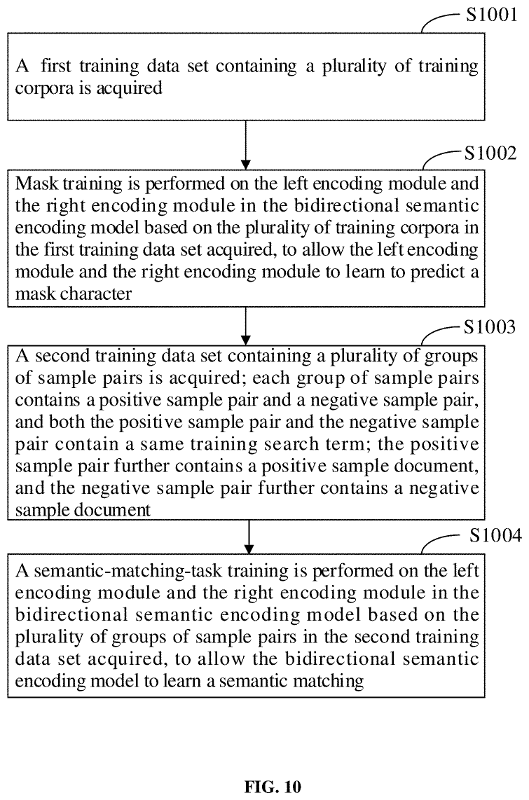

FIG. 10 shows a schematic diagram according to a fourth embodiment of the present disclosure. On the basis of the technical solution of the embodiment shown in FIG. 9, the technical solution of the present disclosure is described in more detail in the embodiment shown in FIG. 10. As shown in FIG. 10, the method of training the bidirectional semantic encoding model in this embodiment may specifically include following steps.

In step S1001, a first training data set containing a plurality of training corpora is acquired.

In step S1002, mask training is performed on the left encoding module and the right encoding module in the bidirectional semantic encoding model based on the plurality of training corpora in the first training data set acquired, to allow the left encoding module and the right encoding module to learn to predict a mask character.

In step S1003, a second training data set containing a plurality of groups of sample pairs is acquired. Each group of sample pairs contains a positive sample pair and a negative sample pair, and both the positive sample pair and the negative sample pair contain a same training search term. The positive sample pair further contains a positive sample document, and the negative sample pair further contains a negative sample document.

The training search term contained in the sample pair in this embodiment may be a search term from the user, such as Query. The positive sample document in the positive sample pair may be a document related to the Query. The negative sample document in the negative sample pair may be a document not related to the Query. The sample pair in this embodiment may be manually labeled, or may be automatically collected by a user click and other behavior logs. If the Query and the document forms a positive sample, then each segment in the Query and the document is a positive sample, and vice versa.

In step S1004, a semantic-matching-task training is performed on the left encoding module and the right encoding module in the bidirectional semantic encoding model based on the plurality of groups of sample pairs in the second training data set acquired, to allow the bidirectional semantic encoding model to learn a semantic matching.

It should be noted that in this embodiment, the training of the bidirectional semantic encoding model includes both the training in the steps S1001 to S1002 and the training in the steps S1003 to S1004. By performing the mask character training in the steps S1001 to S1002 prior to the steps S1003 to S1004, a training effect of the bidirectional semantic encoding model may be further enhanced. Optionally, in practice, the training of the bidirectional semantic encoding model may only include the training in the step S1003 to S1004 described above.

Further optionally, the step S1002 in this embodiment may be specifically executed in two manners.

In a first manner, the mask training is performed on the left encoding module and the right encoding module in the bidirectional semantic encoding model respectively based on the plurality of training corpora in the first training data set acquired.

In other words, in this training manner, a parameter of the left encoding module and a parameter of the right encoding module may not be shared with each other, and the mask training may be performed on the left encoding module and the right encoding module respectively.

In a second manner, the mask training is performed on the left encoding module or the right encoding module in the bidirectional semantic encoding model based on the plurality of training corpora in the first training data set acquired, and the parameter of the left encoding module or the parameter of the right encoding module on which the mask training is performed is shared to the right encoding module or the left encoding module on which the mask training is not performed.

In this training manner, the parameter of the left encoding module and the parameter of the right encoding module may be shared with each other. The mask training may be performed on only one of the left encoding module and the right encoding module, and the trained parameter is then shared to another of the left encoding module and the right encoding module.

No matter which training manner is adopted, the trained bidirectional semantic encoding model may effectively improve the accuracy of the semantic feature representation for the document segment, so that the accuracy of the semantic feature representation for the target document may be effectively improved.

For example, the performing the mask training on the left encoding module in the bidirectional semantic encoding model based on the plurality of training corpora in the first training data set acquired may specifically include following steps.

In step (a1), each training corpus of the plurality of training corpora is masked and segmented to obtain a training corpus segment sequence.

For example, the training corpus may be segmented in a manner that the target document in the embodiment shown in FIG. 1 is segmented. The training corpus in this embodiment may also be in a form of a long text. Similarly, at least two training corpus segments may be contained in the segment sequence of the segmented training corpus. Reference may be made to the embodiments described above, which will not be repeated here.

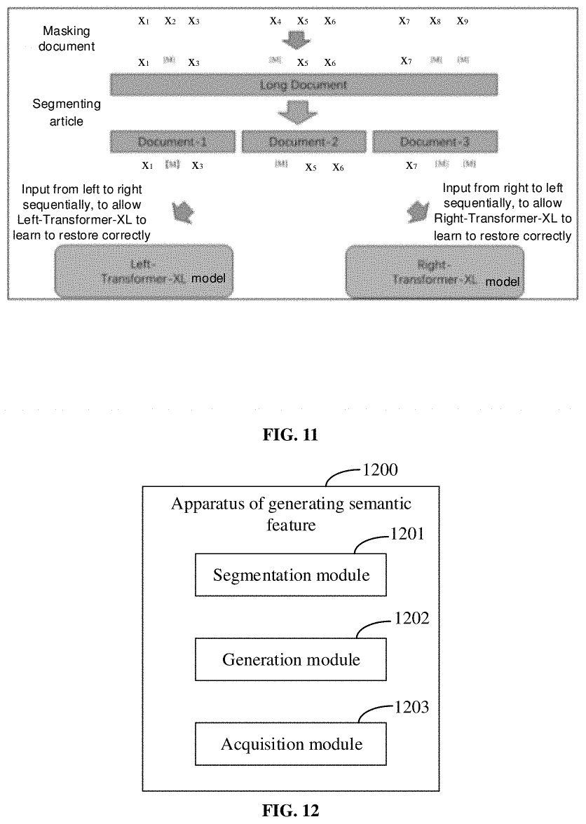

In addition, in this embodiment, a mask for the training corpus may be a random mask. For example, the training corpus may be a document containing X1, X2, . . . X9. FIG. 11 shows a schematic diagram of mask training for the left encoding module and the right encoding module of the embodiment. As shown in FIG. 11, in this embodiment, masking X2, X4, X8 and X9 is illustrated by way of example. The document is segmented with a segment length of 3 to obtain three document segments including Document-1, Document-2 and Document-3. Document-1 contains X1, [M], X3, Document-2 contains [M], X5, X6, and Document-3 contains

X7, [M], [M], and [M] is a mask character.

In step (b1), each training corpus segment in the training corpus segment sequence is input into the left encoding module from left to right sequentially.

In step (c1), a mask character in the each training corpus segment is predicted by encoding each input training corpus segment and decoding an encoded feature using the left encoding module, to acquire the mask character.

For example, Document-1, Document-2 and Document-3 may be sequentially input into the left encoding module. The left encoding module first performs encoding based on X1, [M] and X3 contained in the input Document-1 to obtain Lmem-Doc-1, and then performs decoding based on the encoded result Lmem-Doc-1, to predict the mask character [M]. Next, the left encoding module performs encoding based on Lmem-Doc-1 and [M], X5, X6 contained in the input Document-2 to obtain Lmem-Doc-2, and then performs decoding based on the encoded result Lmem-Doc-2, to predict the mask character [M]. Similarly, the left encoding module performs encoding based on Lmem-Doc-2 of Document 2 and X7, [M], [M] contained in the input Document-3 to obtain Lmem-Doc-3, and then performs decoding based on the encoded result Lmem-Doc-3, to predict two mask characters [M].

In step (d1), a first loss function is constructed based on a real mask character in the each training corpus segment and the mask character predicted by the left encoding module.

In the training process of this embodiment, the first loss function may be constructed based on each prediction result, or the first loss function may be constructed as a whole based on a prediction result of a training corpus. For example, the first loss function constructed may be used to indicate a difference between the mask character predicted by the left encoding module and the real mask character, for example, a difference indicated by a character feature between the mask character predicted by the left encoding module and the real mask character may be taken. The smaller the difference is, the closer the two are, and the greater the difference is, the farther the two are.

For example, when the first loss function is constructed based on a plurality of prediction results for a training corpus, it may take an average difference or a mean square difference indicated by a character feature between each predicted mask character and a corresponding real mask character, which is not limited here.

In step (e1), it is detected whether the first loss function converges or not. Step (f1) is executed if the first loss function does not converge, and step (g1) is executed if the first loss function converges.

In step (f1), the parameter of the left encoding module is adjusted so that the first loss function tends to converge. Then, the step (a1) is executed to select a next training corpus to continue training.

In step (g1), it is detected whether the first loss function always converges during the training of a preset number of continuous rounds, or whether the number of training rounds reaches a preset threshold. If so, the parameter of the left encoding module is determined, then the left encoding module is determined, and the training ends. If not, the step (a1) is executed to select a next training corpus to continue training.

Steps (a1) to (f1) are a process of training the left encoding module.

Step (g1) is executed to determine whether a training cut-off condition for the left encoding module is satisfied. In this embodiment, two training cut-off conditions are illustrated by way of example. A first training cut-off condition is that the first loss function always converges during the training of the preset number of continuous rounds. If the first loss function always converges, it may be considered that the training of the left encoding module is complete. The preset number of continuous rounds may be set according to actual needs. For example, the preset number may be 80, 100, 200 or other positive integers, which is not limited here. A second training cut-off condition is set to prevent a case that the first loss function has always been converging but may never reach convergence. In this case, a maximum number of training rounds may be set. When a number of training rounds reaches the maximum number of training rounds, it may be considered that the training of the left encoding module is complete. For example, according to actual needs, a preset threshold may be set to a value of one million or other larger orders of magnitude, which is not limited here.

In the mask training process of this embodiment, a Masked Language Model (MLM) of a Bidirectional Encoder Representation from Transformers (BERT) based on Transformers or a Permutation Language Model (PLM) mechanism of an XLNet model may be used for learning, which may refer to the related art and will not be repeated here. However, different from the mask training of the conventional BERT and XLNet that may only learn within the segment, the mask training of the left encoding module and the right encoding module in the bidirectional semantic encoding model in this embodiment may allow the model to learn based on the content of the context, so that a learning effect of the mask training is further improved.

Through the training of the left encoding module described above, the trained left encoding module may accurately predict the mask information, so as to accurately express the semantic feature of the segment processed by the left encoding module.

For another example, the performing the mask training on the right encoding module in the bidirectional semantic encoding model based on the plurality of training corpora in the first training data set acquired may specifically include following steps.

In step (a2), each training corpus of the plurality of training corpora is masked and segmented to obtain a training corpus segment sequence. At least two training corpus segments are contained in the training corpus segment sequence.

In step (b2), each training corpus segment in the training corpus segment sequence is input into the right encoding module sequentially from right to left.

In step (c2), a mask character in the each training corpus segment is predicted by encoding each input training corpus segment and decoding an encoded feature using the right encoding module, to acquire the mask character.

As shown in FIG. 11, different from the mask training of the left encoding module, Document-3, Document-2 and Document-1 may be sequentially input into the right encoding module. The right encoding module first performs encoding based on X7, [M], [M] contained in the input Document-3 to obtain Rmem-Doc-3, and then performs decoding based on the encoded result Rmem-Doc-3, to predict two mask characters [M]. Next, the right encoding module performs encoding based on Rmem-Doc-3 and [M], X5, X6 contained in the input Document-2 to obtain Rmem-Doc-2, and then performs decoding based on the encoded result Rmem-Doc-2, to predict the mask character [M]. Similarly, the right encoding module then performs encoding based on Rmem-Doc-2 of Document 2 and X1, [M], X3 contained in the input Document-1 to obtain Rmem-Doc-1, and then performs decoding based on the encoded result Rmem-Doc-1, to predict the mask character [M].

In step (d2), a second loss function is constructed based on a real mask character in the each training corpus segment and the mask character predicted by the right encoding module.

A construction of the second loss function is similar to that of the first loss function described above. Reference may be made to the construction of the first loss function, which will not be repeated here.

In step (e2), it is detected whether the second loss function converges or not. Step (f2) is executed if the second loss function does not converge, and step (g2) is executed if the second loss function converges.

In step (f2), the parameter of the right encoding module is adjusted so that the second loss function tends to converge. Then, the step (a2) is executed to select a next training corpus to continue training.

In step (g2), it is detected whether the second loss function always converges during the training of a preset number of continuous rounds, or whether the number of training rounds reaches a preset threshold. If so, the parameter of the right encoding module is determined, then the right encoding module is determined, and the training ends. If not, the step (a2) is executed to select a next training corpus to continue training.

The steps (a2) to (f2) are a process of training the right encoding module.

The step (g2) is executed to determine whether a training cut-off condition for the right encoding module is satisfied, which is similar to the step (g1) described above. Reference may be made to the above description, which will not be repeated here.

Through the training of the right encoding module described above, the trained right encoding module may accurately predict the mask information, so as to accurately express the semantic feature of the segment processed by the right encoding module.

Furthermore, optionally, the step S1004 in this embodiment may specifically include following steps.

In step (a3), a semantic feature of the training search term is acquired by using the bidirectional semantic encoding model including the left encoding module and the right encoding module, based on the training search term in the each group of sample pairs.

For example, in the specific implementation of this step, for each group of sample pairs, a left encoded feature of the training search term may be first acquired. The left encoded feature of the training search term is obtained by encoding the training search term using the left encoding module. Then, a right encoded feature of the training search term may be acquired. The right encoded feature of the training search term is obtained by encoding the training search term using the right encoding module. Finally, the left encoded feature of the training search term and the right encoded feature of the training search term are stitched to obtain the semantic feature of the training search term.

In step (b3), a semantic feature of the positive sample document is acquired by using the bidirectional semantic encoding model including the left encoding module and the right encoding module, based on the positive sample document in the each group of sample pairs.

In step (c3), a semantic feature of the negative sample document is acquired by using the bidirectional semantic encoding model including the left encoding module and the right encoding module, based on the negative sample document in the each group of sample pairs.

In step (d3), a third loss function is constructed based on a first semantic similarity between the semantic feature of the training search term and the semantic feature of the positive sample document and a second semantic similarity between the semantic feature of the training search term and the semantic feature of the negative sample document, so that a difference between the first semantic similarity and the second semantic similarity is greater than a preset threshold.

In this embodiment, the third loss function is constructed to make the first semantic similarity between the semantic feature of the training search term and the semantic feature of the positive sample document sufficiently large, and the second semantic similarity between the semantic feature of the training search term and the semantic feature of the negative sample document sufficiently small. In order to control the difference between the first semantic similarity and the second semantic similarity, it may be set that the difference between the first semantic similarity and the second semantic similarity is greater than the preset threshold. When the preset threshold is sufficiently large, it may be ensured that the first semantic similarity is sufficiently large, and the second semantic similarity is sufficiently small.

In practice, different training strategies may be used to set different third loss functions, which will not be repeated here.

In step (e3), it is detected whether the third loss function converges or not. Step (f3) is executed if the third loss function does not converge, and step (g3) is executed if the third loss function converges.

In step (f3), the parameter of the left encoding module and the parameter of the right encoding module in the bidirectional semantic encoding model are adjusted so that the third loss function tends to converge. Then, the step (a3) is executed to select a next group of sample pairs to continue training.

In this embodiment, the parameter of the left encoding module and the parameter of the right encoding module in the bidirectional semantic encoding model may be adjusted in two manners.

In a first manner, the parameter of the left encoding module and the parameter of the right encoding module are shared with each other. In this case, the adjusted parameters of the left encoding module and the right encoding module are always synchronized.

In a second manner, the parameter of the left encoding module and the parameter of the right encoding module may not be shared with each other. In this case, the parameter of the left encoding module and the parameter of the right encoding module may be adjusted randomly and may not be synchronized, as long as the third loss function tends to converge.

No matter which training manner is selected, the accuracy of the semantic feature represented by the trained bidirectional semantic encoding model may be effectively ensured.

In step (g3), it is detected whether the third loss function always converges during the training of a preset number of continuous rounds, or whether the number of training rounds reaches a preset threshold. If so, the parameter of the left encoding module and the parameter of the right encoding module are determined, then the bidirectional semantic encoding model is determined, and the training ends. If not, the step (a3) is executed to select a next group of sample pairs to continue training.

The steps (a3) to (f3) are a process of training the bidirectional semantic encoding model.

The step (g3) is executed to determine whether a training cut-off condition for the bidirectional semantic encoding model is satisfied, which is similar to the step (g1) and the step (g2) described above. Reference may be made to the above description, which will not be repeated here.

After the bidirectional semantic encoding model is trained as above, the bidirectional semantic encoding model may fully consider all the information of context when expressing the semantic feature, so that the accuracy of the semantic expression of the bidirectional semantic encoding model may be effectively improved.

Further optionally, in the specific implementation, the step (b3) in the above embodiment may include following steps.

In step (a4), the positive sample document in each group of sample pairs is segmented to obtain a positive sample document segment sequence.

Reference may be made to the segmentation of the target document in the above embodiment. The principle of implementation is the same and will not be repeated here.

In step (b4), a left encoded feature of each positive sample document segment is acquired by inputting the each positive sample document segment in the positive sample document segment sequence into the left encoding module from left to right sequentially and encoding each input positive sample document segment by using the left encoding module.

For example, the left encoded feature of each positive sample document segment may be acquired with reference to the operation principle of the left encoding module in the embodiment shown in FIG. 6.

In step (c4), a right encoded feature of each positive sample document segment is acquired by inputting the each positive sample document segment in the positive sample document segment sequence into the right encoding module from right to left sequentially and encoding each input positive sample document segment by using the right encoding module.

For example, the right encoded feature of each positive sample document segment may be acquired with reference to the operation principle of the right encoding module in the embodiment shown in FIG. 7.

In step (d4), the left encoded feature of the each positive sample document segment in the positive sample document and the right encoded feature of the each positive sample document segment in the positive sample document are stitched to obtain a semantic feature of the each positive sample document segment.

Referring to the related description of the above embodiments, by stitching the left encoded feature of the each positive sample document segment and the right encoded feature of the each positive sample document segment, the semantic feature of the each positive sample document segment obtained may fully refer to all the context information in the positive sample document, so that the semantic feature of positive sample document segment may be expressed more accurately.

In step (e4), a semantic feature of a positive sample document segment with a largest similarity to the semantic feature of the training search term is determined as the semantic feature of the positive sample document, based on the semantic feature of the each positive sample document segment in the positive sample document and the semantic feature of the training search term.

Further optionally, in the specific implementation, the step (b4) may include following steps.

In step (a5), the negative sample document in each group of sample pairs is segmented to obtain a negative sample document segment sequence.

Reference may be made to the segmentation of the target document in the above embodiment. The principle of implementation is the same and will not be repeated here.

In step (b5), a left encoded feature of each negative sample document segment is acquired by inputting the each negative sample document segment in the negative sample document segment sequence into the left encoding module from left to right sequentially and encoding each input negative sample document segment by using the left encoding module.

In step (c5), a right encoded feature of each negative sample document segment is acquired by inputting the each negative sample document segment in the negative sample document segment sequence into the right encoding module from right to left sequentially and encoding each input negative sample document segment by using the right encoding module.

In step (d5), the left encoded feature of the each negative sample document segment in the negative sample document and the right encoded feature of the each negative sample document segment in the negative sample document are stitched to obtain a semantic feature of the each negative sample document segment.

In step (e5), a semantic feature of a negative sample document segment with a largest similarity to the semantic feature of the training search term is determined as the semantic feature of the negative sample document, based on the semantic feature of the each negative sample document segment in the negative sample document and the semantic feature of the training search term.

It should be noted that the process of acquiring the semantic feature of the negative sample document in steps (a5) to (e5) is similar to the process of acquiring the semantic feature of the positive sample document in steps (a4) to (e4). The specific implementation may refer to the implementation of steps (a4) to (e4) and will not be repeated here.

In the method of training the bidirectional semantic encoding model in this embodiment, by training the left encoding module and the right encoding module in the bidirectional semantic encoding model in the training manner described above, the trained bidirectional semantic encoding model may fully refer to the context information when expressing the semantic feature, so that the semantic feature obtained may be more accurate.

FIG. 12 shows a schematic diagram according to a fifth embodiment of the present disclosure. As shown in FIG. 12, this embodiment provides an apparatus 1200 of generating a semantic feature, including:

a segmentation module 1201 used to segment a target document to obtain a segment sequence of the target document;

a generation module 1202 used to generate a semantic feature of each document segment in the segment sequence of the target document by using a pre-trained bidirectional semantic encoding model; and

an acquisition module 1203 used to acquire a semantic feature of the target document based on the semantic feature of the each document segment in the segment sequence of the target document.

The implementation principle and technical effect of generating the semantic feature by using the apparatus 1200 in this embodiment are the same as those in the related method embodiments, which will not be repeated here.

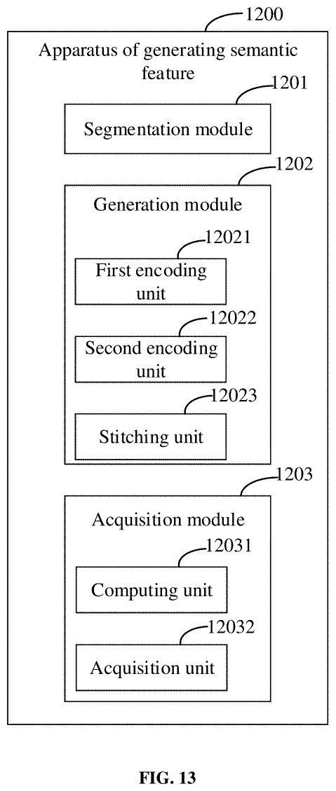

FIG. 13 shows a schematic diagram according to a sixth embodiment of the present disclosure. On the basis of the technical solution of the embodiment shown in FIG. 12, the technical solution of the present disclosure is described in more detail in the embodiment shown in FIG. 13.

As shown in FIG. 13, in the apparatus of generating the semantic feature in this embodiment, the generation module 1202 includes:

a first encoding unit 12021 used to acquire a left encoded feature of the each document segment in the segment sequence of the target document by using a left encoding module in the bidirectional semantic encoding model;

a second encoding unit 12022 used to acquire a right encoded feature of the each document segment in the segment sequence of the target document by using a right encoding module in the bidirectional semantic encoding model; and

a stitching unit 12023 used to stitch the left encoded feature of the each document fragment in the segment sequence of the target document and the right encoded feature of the each document fragment in the segment sequence of the target document, so as to obtain the semantic feature of the each document segment.

Further optionally, in the apparatus of generating the semantic feature in this embodiment, the acquisition module 1203 is further used to:

acquire the semantic feature of the target document based on the semantic feature of the each document segment in the segment sequence of the target document and by referring to a semantic feature of a search term to be matched.

Further optionally, as shown in FIG. 13, in the apparatus of generating the semantic feature in this embodiment, the acquisition module 1203 includes:

a calculation unit 12031 used to calculate a similarity between the semantic feature of the each document segment in the segment sequence of the target document and the semantic feature of the search term to be matched; and

an acquisition unit 12032 used to determine a semantic feature of a document segment with a largest similarity to the semantic feature of the search term to be matched as the semantic feature of the target document, based on the similarity between the semantic feature of the each document segment and the semantic feature of the search term to be matched.

The implementation principle and technical effect of generating the semantic feature by using the apparatus 1200 in this embodiment are the same as those in the related method embodiments, which will not be repeated here.

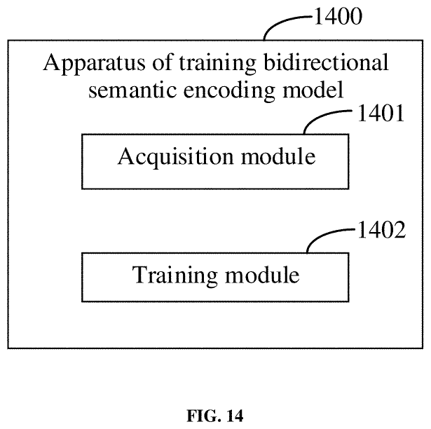

FIG. 14 shows a schematic diagram according to a seventh embodiment of the present disclosure. As shown in FIG. 14, this embodiment provides an apparatus 1400 of training a bidirectional semantic encoding model, including:

an acquisition module 1401 used to acquire a training data set; and

a training module 1402 used to train the bidirectional semantic encoding model including a left encoding module and a right encoding module, based on the training data set acquired.

The implementation principle and technical effect of training the bidirectional semantic encoding model by using the apparatus 1400 in this embodiment are the same as those in the related method embodiments, which will not be repeated here.

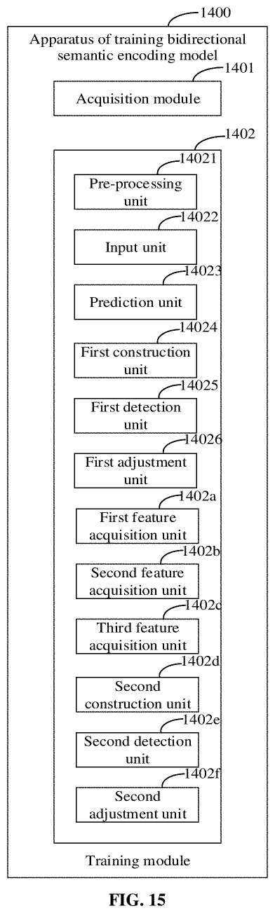

FIG. 15 shows a schematic diagram according to an eighth embodiment of the present disclosure. On the basis of the technical solution of the embodiment shown in FIG. 14, the technical solution of the present disclosure is described in more detail in the embodiment shown in FIG. 15.

For example, the acquisition module 1401 in this embodiment may be used to acquire a first training data set containing a plurality of training corpora.

Further optionally, the training module 1402 is further used to perform a mask training on the left encoding module and the right encoding module in the bidirectional semantic encoding model based on the plurality of training corpora in the first training data set acquired, to allow the left encoding module and the right encoding module to learn to predict a mask character.

Further optionally, the training module 1402 in this embodiment is further used to:

perform the mask training on the left encoding module and the right encoding module in the bidirectional semantic encoding model respectively based on the plurality of training corpora in the first training data set acquired; or

perform the mask training on the left encoding module or the right encoding module in the bidirectional semantic encoding model based on the plurality of training corpora in the first training data set acquired, and sharing the parameter of the left encoding module or the parameter of the right encoding module on which the mask training is performed to the right encoding module or the left encoding module on which the mask training is not performed.

Further optionally, as shown in FIG. 15, in the apparatus of training the bidirectional semantic encoding model, the training module 1402 includes:

a pre-processing unit 14021 used to mask each training corpus of the plurality of training corpora, and segment the each training corpus to obtain a training corpus segment sequence;

an input unit 14022 used to input each training corpus segment in the training corpus segment sequence into the left encoding module from left to right sequentially;

a prediction unit 14023 used to predict a mask character in the each training corpus segment by encoding each input training corpus segment and decoding an encoded feature using the left encoding module, so as to acquire the mask character;

a first construction unit 14024 used to construct a first loss function based on a real mask character in the each training corpus segment and the mask character predicted by the left encoding module;

a first detection unit 14025 used to detect whether the first loss function converges or not; and

a first adjustment unit 14026 used to adjust the parameter of the left encoding module so that the first loss function tends to converge, in response to detecting that the first loss function does not converge.

Further optionally, the input unit 14022 is further used to input each training corpus segment in the training corpus segment sequence into the right encoding module from right to left sequentially; the prediction unit 14023 is further used to predict a mask character in the each training corpus segment by encoding each input training corpus segment and decoding an encoded feature using the right encoding module, so as to acquire the mask character; the first construction unit 14024 is further used to construct a second loss function based on a real mask character in the each training corpus segment and the mask character predicted by the right encoding module; the first detection unit 14025 is further used to detect whether the second loss function converges or not; and the first adjustment unit 14026 is further used to adjust the parameter of the right encoding module so that the second loss function tends to converge, in response to detecting that the second loss function does not converge.

Further optionally, in the apparatus 1400 of training the bidirectional semantic encoding model, the acquisition module 1401 is further used to acquire a second training data set containing a plurality of groups of sample pairs. Each group of sample pairs contains a positive sample pair and a negative sample pair, and both the positive sample pair and the negative sample pair contain a same training search term. The positive sample pair further contains a positive sample document, and the negative sample pair further contains a negative sample document.

Further optionally, in the apparatus 1400 of training the bidirectional semantic encoding model, the training module 1402 is further used to perform a semantic-matching-task training on the left encoding module and the right encoding module in the bidirectional semantic encoding model based on the plurality of groups of sample pairs in the second training data set acquired, to allow the bidirectional semantic encoding model to learn a semantic matching.

Further optionally, as shown in FIG. 15, in the apparatus of training the bidirectional semantic encoding model, the training module 1402 further includes:

a first feature acquisition unit 1402a used to acquire a semantic feature of the training search term by using the bidirectional semantic encoding model including the left encoding module and the right encoding module, based on the training search term in the each group of sample pairs;

a second feature acquisition unit 1402b used to acquire a semantic feature of the positive sample document by using the bidirectional semantic encoding model including the left encoding module and the right encoding module, based on the positive sample document in the each group of sample pairs;

a third feature acquisition unit 1402c used to acquire a semantic feature of the negative sample document by using the bidirectional semantic encoding model including the left encoding module and the right encoding module, based on the negative sample document in the each group of sample pairs;

a second construction unit 1402d used to construct a third loss function based on a first semantic similarity between the semantic feature of the training search term and the semantic feature of the positive sample document and a second semantic similarity between the semantic feature of the training search term and the semantic feature of the negative sample document;

a second detection unit 1402e used to detect whether the third loss function converges or not; and

a second adjustment unit 1402f used to adjust the parameter of the left encoding module and the right encoding module in the bidirectional semantic encoding model so that the third loss function tends to converge, in response to detecting that the third loss function does not converge.

Further optionally, the first feature acquisition unit 1402a is used to:

acquire a left encoded feature of the training search term obtained by encoding the training search term using the left encoding module;

acquire a right encoded feature of the training search term obtained by encoding the training search term using the right encoding module; and

stitch the left encoded feature of the training search term and the right encoded feature of the training search term so as to obtain the semantic feature of the training search term.

Further optionally, the second feature acquisition unit 1402b is used to:

segment the positive sample document in each group of sample pairs to obtain a positive sample document segment sequence;

acquire a left encoded feature of each positive sample document segment by inputting the each positive sample document segment in the positive sample document segment sequence into the left encoding module from left to right sequentially and encoding each input positive sample document segment by using the left encoding module;

acquire a right encoded feature of each positive sample document segment by inputting the each positive sample document segment in the positive sample document segment sequence into the right encoding module from right to left sequentially and encoding each input positive sample document segment by using the right encoding module;

stitch the left encoded feature of the each positive sample document segment in the positive sample document and the right encoded feature of the each positive sample document segment in the positive sample document so as to obtain a semantic feature of the each positive sample document segment; and

determine a semantic feature of a positive sample document segment with a largest similarity to the semantic feature of the training search term as the semantic feature of the positive sample document, based on the semantic feature of the each positive sample document segment in the positive sample document and the semantic feature of the training search term.

Further optionally, the third feature acquisition unit 1402c is used to:

segment the negative sample document in each group of sample pairs to obtain a negative sample document segment sequence;

acquire a left encoded feature of each negative sample document segment by inputting the each negative sample document segment in the negative sample document segment sequence into the left encoding module from left to right sequentially and encoding each input negative sample document segment by using the left encoding module;

acquire a right encoded feature of each negative sample document segment by inputting the each negative sample document segment in the negative sample document segment sequence into the right encoding module from right to left sequentially and encoding each input negative sample document segment by using the right encoding module;

stitch the left encoded feature of the each negative sample document segment in the negative sample document and the right encoded feature of the each negative sample document segment in the negative sample document so as to obtain a semantic feature of the each negative sample document segment; and

determine a semantic feature of a negative sample document segment with a largest similarity to the semantic feature of the training search term as the semantic feature of the negative sample document, based on the semantic feature of the each negative sample document segment in the negative sample document and the semantic feature of the training search term.

In practice, the training module 1402 may only include the pre-processing unit 14021 to the first adjustment unit 14026, or only include the first feature acquisition unit 1402a to the second adjustment unit 1402f, or may include both. In the embodiment shown in FIG. 14, the training module 1402 including both is illustrated by way of example.

The implementation principle and technical effect of training the bidirectional semantic encoding model by using the apparatus 1400 in this embodiment are the same as those in the related method embodiments, which will not be repeated here.

According to the technology of the present disclosure, by adopting the pre-trained bidirectional semantic encoding model, an accuracy of the semantic feature of the each document segment in the target document may be effectively improved, so that an accuracy of the semantic feature representation for the target document may be effectively improved. Moreover, according to the technology of the present disclosure, the training data set is acquired, and the bidirectional semantic encoding model including the left encoding module and the right encoding module is trained based on the training data set acquired. In this way, the bidirectional semantic encoding model may be effectively trained, so that an accuracy of the semantic feature represented by the bidirectional semantic encoding model may be effectively improved.

According to the embodiments of the present disclosure, the present disclosure further provides an electronic device, a readable storage medium, and a computer program product.

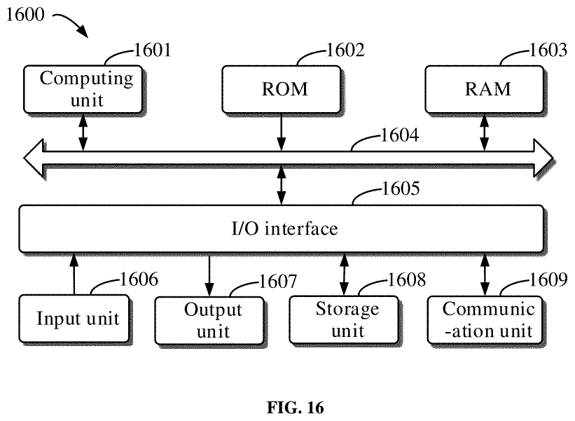

FIG. 16 shows a schematic block diagram of an electronic device 1600 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components, connections and relationships between the components, and functions of the components in the present disclosure are merely examples, and are not intended to limit the implementation of the present disclosure described and/or required herein.

As shown in FIG. 16, the electronic device 1600 includes a computing unit 1601, which may perform various appropriate actions and processing based on a computer program stored in a read-only memory (ROM) 1602 or a computer program loaded from a storage unit 1608 into a random access memory (RAM) 1603. Various programs and data required for the operation of the electronic device 1600 may be stored in the RAM 1603. The computing unit 1601, the ROM 1602 and the RAM 1603 are connected to each other through a bus 1604. An input/output (I/O) interface 1605 is also connected to the bus 1604.

Various components in the electronic device 1600, including an input unit 1606 such as a keyboard, a mouse, etc., an output unit 1607 such as various types of displays, speakers, etc., a storage unit 1608 such as a magnetic disk, an optical disk, etc., and a communication unit 1609 such as a network card, a modem, a wireless communication transceiver, etc., are connected to the I/O interface 1605. The communication unit 1609 allows the electronic device 1600 to exchange information/data with other devices through a computer network such as the Internet and/or various telecommunication networks.

The computing unit 1601 may be various general-purpose and/or special-purpose processing components with processing and computing capabilities. Some examples of the computing unit 1601 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1601 executes the various methods and processes described above, such as the method of generating the semantic feature or the method of training the bidirectional semantic encoding model. For example, in some embodiments, the method of generating the semantic feature or the method of training the bidirectional semantic encoding model may be implemented as a computer software program, which is tangibly contained in a machine-readable medium, such as the storage unit 1608. In some embodiments, a part or all of the computer programs may be loaded into and/or installed on the electronic device 1600 via the ROM 1602 and/or the communication unit 1609. When the computer program is loaded into the RAM 1603 and executed by the computing unit 1601, one or more steps of the method of generating the semantic feature or the method of training the bidirectional semantic encoding model described above may be executed. Alternatively, in other embodiments, the computing unit 1601 may be configured to perform the method of generating the semantic feature or the method of training the bidirectional semantic encoding model in any other suitable manner (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard parts (ASSP), a system on chip (SOC), a complex programming logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes used to implement the method of the present disclosure may be written in any combination of one or more programming languages. These program codes may be provided to a processor or a controller of a general-purpose computer, a dedicated computer or other programmable data processing devices, so that when the program codes are executed by the processor or the controller, functions/operations specified in the flowchart and/or the block diagram may be implemented. The program codes may be executed entirely or partly on the machine, or executed partly on the machine and partly executed on a remote machine as an independent software package, or executed entirely on the remote machine or a server.

In the context of the present disclosure, the machine-readable medium may be a tangible medium, which may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include one or more wire-based electrical connection, portable computer disk, hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the systems and technologies described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), internet and a block-chain network.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, and the server is a host product in the cloud computing service system to solve shortcomings of difficult management and weak business scalability in conventional physical host and VPS services (“Virtual Private Server” or “VPS” for short). The server may also be a server of a distributed system or a server combined with block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating a semantic feature, comprising:
segmenting a target document to obtain a segment sequence of the target document;
generating a semantic feature of each document segment in the segment sequence of the target document by using a pre-trained bidirectional semantic encoding model; and
acquiring a semantic feature of the target document based on the semantic feature of the each document segment in the segment sequence of the target document.

2. The method of claim 1, wherein the generating a semantic feature of each document segment in the segment sequence of the target document by using a pre-trained bidirectional semantic encoding model comprises:
acquiring a left encoded feature of the each document segment in the segment sequence of the target document by using a left encoding module in the bidirectional semantic encoding model;
acquiring a right encoded feature of the each document segment in the segment sequence of the target document by using a right encoding module in the bidirectional semantic encoding model; and
stitching, for the each document segment in the segment sequence of the target document, the left encoded feature and the right encoded feature, so as to obtain the semantic feature of the each document segment.

3. The method of claim 1, wherein the acquiring a semantic feature of the target document based on the semantic feature of the each document segment in the segment sequence of the target document comprises:
acquiring the semantic feature of the target document based on the semantic feature of the each document segment in the segment sequence of the target document and by referring to a semantic feature of a search term to be matched.

4. The method of claim 3, wherein the acquiring the semantic feature of the target document based on the semantic feature of the each document segment in the segment sequence of the target document and by referring to a semantic feature of a search term to be matched comprises:
calculating a similarity between the semantic feature of the each document segment in the segment sequence of the target document and the semantic feature of the search term to be matched; and
determining a semantic feature of a document segment with a largest similarity to the semantic feature of the search term to be matched, as the semantic feature of the target document, based on the similarity between the semantic feature of the each document segment and the semantic feature of the search term to be matched.

5. A method of training a bidirectional semantic encoding model, comprising:
acquiring a training data set; and
training the bidirectional semantic encoding model comprising a left encoding module and a right encoding module, based on the training data set acquired.

6. The method of claim 5, wherein the acquiring a training data set comprises:
acquiring a first training data set containing a plurality of training corpora.

7. The method of claim 6, wherein the training the bidirectional semantic encoding model comprising a left encoding module and a right encoding module, based on the training data set acquired comprises:
performing a mask training on the left encoding module and the right encoding module in the bidirectional semantic encoding model based on the plurality of training corpora in the first training data set acquired, to allow the left encoding module and the right encoding module to learn to predict a mask character.

8. The method of claim 7, wherein the performing a mask training on the left encoding module and the right encoding module in the bidirectional semantic encoding model based on the plurality of training corpora in the first training data set acquired comprises:
performing the mask training on the left encoding module and the right encoding module in the bidirectional semantic encoding model respectively based on the plurality of training corpora in the first training data set acquired; or
performing the mask training on the left encoding module in the bidirectional semantic encoding model or performing the mask training on the right encoding module in the bidirectional semantic encoding model, based on the plurality of training corpora in the first training data set acquired, and sharing a parameter of the left encoding module or a parameter of the right encoding module on which the mask training is performed, to the right encoding module or the left encoding module on which the mask training is not performed.

9. The method of claim 8, wherein the performing the mask training on the left encoding module in the bidirectional semantic encoding model based on the plurality of training corpora in the first training data set acquired comprises:
masking each training corpus of the plurality of training corpora, and segmenting the each training corpus to obtain a training corpus segment sequence;
inputting each training corpus segment in the training corpus segment sequence into the left encoding module from left to right sequentially;
predicting a mask character in the each training corpus segment, by encoding each input training corpus segment and decoding an encoded feature using the left encoding module, to acquire the mask character;
constructing a first loss function based on a real mask character in the each training corpus segment and the mask character predicted by the left encoding module;
detecting whether the first loss function converges or not; and
adjusting the parameter of the left encoding module so that the first loss function tends to converge, in response to detecting that the first loss function does not converge.

10. The method of claim 8, wherein the performing the mask training on the right encoding module in the bidirectional semantic encoding model based on the plurality of training corpora in the first training data set acquired comprises:
masking each training corpus of the plurality of training corpora, and segmenting the each training corpus to obtain a training corpus segment sequence;
inputting each training corpus segment in the training corpus segment sequence into the right encoding module from right to left sequentially;
predicting a mask character in the each training corpus segment by encoding each input training corpus segment and decoding an encoded feature using the right encoding module, to acquire the mask character;
constructing a second loss function based on a real mask character in the each training corpus segment and the mask character predicted by the right encoding module;
detecting whether the second loss function converges or not; and
adjusting the parameter of the right encoding module so that the second loss function tends to converge, in response to detecting that the second loss function does not converge.

11. The method of claim 5, wherein the acquiring a training data set comprises:
acquiring a second training data set containing a plurality of groups of sample pairs, wherein each group of sample pairs in the plurality of groups of sample pairs contains a positive sample pair and a negative sample pair, and both the positive sample pair and the negative sample pair contain a same training search term, the positive sample pair further contains a positive sample document, and the negative sample pair further contains a negative sample document.

12. The method of claim 11, wherein the training the bidirectional semantic encoding model comprising a left encoding module and a right encoding module based on the training data set acquired comprises:
performing a semantic-matching-task training on the left encoding module and the right encoding module in the bidirectional semantic encoding model based on the plurality of groups of sample pairs in the second training data set acquired, to allow the bidirectional semantic encoding model to learn a semantic matching.

13. The method of claim 12, wherein the performing a semantic-matching-task training on the left encoding module and the right encoding module in the bidirectional semantic encoding model based on the plurality of groups of sample pairs in the second training data set acquired comprises:
acquiring a semantic feature of the training search term by using the bidirectional semantic encoding model comprising the left encoding module and the right encoding module, based on the training search term in the each group of sample pairs,
acquiring a semantic feature of the positive sample document by using the bidirectional semantic encoding model comprising the left encoding module and the right encoding module, based on the positive sample document in the each group of sample pairs;
acquiring a semantic feature of the negative sample document by using the bidirectional semantic encoding model comprising the left encoding module and the right encoding module, based on the negative sample document in the each group of sample pairs;
constructing a third loss function based on a first semantic similarity between the semantic feature of the training search term and the semantic feature of the positive sample document and a second semantic similarity between the semantic feature of the training search term and the semantic feature of the negative sample document;
detecting whether the third loss function converges or not; and
adjusting the parameter of the left encoding module and the right encoding module in the bidirectional semantic encoding module so that the third loss function tends to converge, in response to detecting that the third loss function does not converge.

14. The method of claim 13, wherein the acquiring a semantic feature of the training search term by using the bidirectional semantic encoding model comprising the left encoding module and the right encoding module based on the training search term in the each group of sample pairs comprises:
acquiring a left encoded feature of the training search term, wherein the left encoded feature of the training search term is obtained by encoding the training search term by using the left encoding module;
acquiring a right encoded feature of the training search term, wherein the right encoded feature of the training search term is obtained by encoding the training search term by using the right encoding module; and
stitching the left encoded feature of the training search term and the right encoded feature of the training search term, so as to obtain the semantic feature of the training search term.

15. The method of claim 13, wherein the acquiring a semantic feature of the positive sample document by using the bidirectional semantic encoding model comprising the left encoding module and the right encoding module based on the positive sample document in the each group of sample pairs comprises:
segmenting the positive sample document in each group of sample pairs to obtain a positive sample document segment sequence;
acquiring a left encoded feature of each positive sample document segment, by inputting the each positive sample document segment in the positive sample document segment sequence into the left encoding module from left to right sequentially and encoding each input positive sample document segment by using the left encoding module;
acquiring a right encoded feature of the each positive sample document segment, by inputting the each positive sample document segment in the positive sample document segment sequence into the right encoding module from right to left sequentially and encoding the each input positive sample document segment by using the right encoding module;
stitching the left encoded feature of the each positive sample document segment in the positive sample document and the right encoded feature of the each positive sample document segment in the positive sample document, so as to obtain a semantic feature of the each positive sample document segment; and
determining a semantic feature of a positive sample document segment with a largest similarity to the semantic feature of the training search term, as the semantic feature of the positive sample document, based on the semantic feature of the each positive sample document segment in the positive sample document and the semantic feature of the training search term.

16. The method of claim 13, wherein the acquiring a semantic feature of the negative sample document by using the bidirectional semantic encoding model comprising the left encoding module and the right encoding module based on the negative sample document in the each group of sample pairs comprises:
segmenting the negative sample document in each group of sample pairs to obtain a negative sample document segment sequence;
acquiring a left encoded feature of each negative sample document segment, by inputting the each negative sample document segment in the negative sample document segment sequence into the left encoding module from left to right sequentially and encoding each input negative sample document segment by using the left encoding module;
acquiring a right encoded feature of the each negative sample document segment, by inputting the each negative sample document segment in the negative sample document segment sequence into the right encoding module from right to left sequentially and encoding the each input negative sample document segment by using the right encoding module;
stitching the left encoded feature of the each negative sample document segment in the negative sample document and the right encoded feature of the each negative sample document segment in the negative sample document, to obtain a semantic feature of the each negative sample document segment; and
determining a semantic feature of a negative sample document segment with a largest similarity with the semantic feature of the training search term, as the semantic feature of the negative sample document, based on the semantic feature of the each negative sample document segment in the negative sample document and the semantic feature of the training search term.

17. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

18. A non-transitory computer-readable storage medium having computer instructions stored thereon, wherein the computer instructions, when executed by a computer, cause the computer to implement the method of claim 1.

19. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 5.

20. A non-transitory computer-readable storage medium having computer instructions stored thereon, wherein the computer instructions, when executed by a computer, cause the computer to implement the method of claim 5.
